(19) United States
(12) Patent Application Publication
(10) Pub. No.: US 2021/0347609 A1
(43) Pub. Date: Nov. 11, 2021

(54) POST FRAME CONSTRUCTION SYSTEMS AND METHODS

(71) Applicant: Brandon Jenson, Oregon City, OR (US)

(72) Inventor: Brandon Jenson, Oregon City, OR (US)

(21) Appl. No.: 17/014,952

(22) Filed: Sep. 8, 2020

Related U.S. Application Data
(60) Provisional application No. 63/020,110, filed on May 5, 2020.

(51) Int. Cl. B66B 11/00; B66B 11/04; B66B 11/06

(52) U.S. Cl. CPC B66B 11/0005; B66B 11/0035; B66B 11/06; B66B 11/0492; B66B 11/006

(57) ABSTRACT

A lifting system for post frame construction comprises a winch system coupled to a frame, a first bracket configured to be secured to a portion of a roof framing system, and a pulley system comprising at least two pulley wheels mounted on a second bracket. The frame is configured to be secured to a lower portion of a column of a building structure and the second bracket is configured to be secured to a top of the column.

### CROSS REFERENCE TO RELATED APPLICATION

This application claims the benefit of U.S. Provisional Application No. 63/020,110, filed May 5, 2020. The prior application is incorporated herein by reference in its entirety.

### FIELD

This disclosure is directed to lifting structures along a column and, particularly, to post frame construction systems and methods that require lifting roof framing systems.

### BACKGROUND

Various building systems can require the lifting of heavy objects. For example, when constructing a building using a post frame construction method a roof framing system (e.g., a truss) must be lifted in order for it to be secured to a post or column at a desired installation height. Post frame construction can be a suitable building process for a variety of buildings, including, for example, barns, sheds, stables, and other commercial or agricultural buildings. Lifting roof framing systems into position, however, can be difficult and, in some cases, dangerous since the roof framing systems are heavy, large, and unwieldy. Improvements in constructions processes that make lifting heavy structures along a post or column, such as trusses, easier and/or safer are desirable.

### SUMMARY

Various embodiments of lifting systems are provided herein. In some embodiments, the lifting systems can be used to raise roof framing systems (e.g., trusses) along one or more columns to a desired installation height.

In one embodiment, a lifting system comprises a winch system coupled to a frame, a first bracket configured to be secured to a portion of a roof framing system, and a pulley system comprising at least two pulley wheels mounted on a second bracket. The frame is configured to be secured to a lower portion of a column of a building structure and the second bracket is configured to be secured to a top of the column.

In some embodiments, the winch system comprises a winch cable, a cable hook at a first end of the winch cable, and a motor configured to generate rotational power to raise the cable hook. The winch cable can extend from the winch system and engage with the at least two pulley wheels of the pulley system.

In some embodiments, the frame can include a first side, a second side, and a third side, and the first and third sides are facing one another and the second side is intermediate the first and second sides to provide a three-sided bracket. The first and second sides can be triangular, rectangular, or other shapes. The winch system can include a power source (e.g., a battery). In addition, the winch system can comprise a cable guide secured to the frame.

The first bracket can comprise a braking system, such as one-way angled spike members. The first bracket can also, or alternatively, comprises one or more rollers to facilitate movement of the roof framing system relative to the column.

In another embodiment a method of raising a roof framing system along a column is provided. The method comprises coupling a frame with a winch system to a lower portion of a column of a building structure, coupling a first bracket to a portion of a roof framing system, coupling a second bracket of a pulley system to a top of the column, engaging a cable of the winch system with the at least two pulley wheels, coupling a securing member of the winch system to a structure on the first bracket, and driving a motor of the winch system to raise the roof framing system along a desired length of the column. The method can also include positioning the cable through a cable guide secured to the frame, and/or engaging a braking system to restrict downward movement of the roof framing system. In some embodiments, the braking system comprises one-way angled spike members.

The method can also include engaging one or more rollers on the first bracket with the column to facilitate movement of the roof framing system relative to the column, and/or securing the roof framing system to the column when the roof framing system has been raised to a desired installation height.

In another embodiment, another method of raising a roof framing system along a column is provided. The method comprises coupling a plurality of lifting systems to respective lower portions of a plurality of columns, each lifting system comprising a frame having a winch system secured thereto; coupling a plurality of first brackets to respective portions of a roof framing system; coupling a plurality of pulley systems to the tops of the plurality of columns, each pulley system comprising at least two pulley wheels; engaging a cable of each of the winch systems with the at least two pulley wheels; coupling a securing member of each of the winch systems to a respective structure on the plurality of first brackets; and driving a motor of each of the plurality of lifting systems to raise the roof framing system to a desired installation height. In some embodiments, the motors of each of the plurality of lifting systems are driven simultaneously and in others, the motors are driving in pairs and/or sequentially.

The foregoing and other objects, features, and advantages of the invention will become more apparent from the following detailed description, which proceeds with reference to the accompanying figures.

### BRIEF DESCRIPTION OF THE DRAWINGS

FIG. 1 illustrates a schematic view of a lifting system for raising roof framing systems along a column.

FIG. 2 illustrates a schematic view of a bracket configured to be secured to a portion of a roof framing system.

FIG. 3 illustrates another view of the bracket shown in FIG. 2.

FIG. 4 illustrates a lifting system for raising roof framing systems along a column.

FIG. 5 illustrates a view of a lifting system coupled to a column and engaging a bracket coupled to a roof framing system to lift the roof framing system by a winch system.

FIG. 6 illustrates another view of the lifting system coupled to the column and engaging the bracket coupled to the roof framing system to lift the roof framing system by the winch system.

FIG. 7 illustrates another view of the lifting system coupled to the column and engaging the bracket coupled to the roof framing system to lift the roof framing system by the winch system.

FIG. 8 illustrates a pulley system coupled to a top portion of a column.

FIG. 9 illustrates a plurality of lifting systems being collectively operated to raise a roof framing system.

FIG. 10 illustrates another view of the plurality of lifting systems being collectively operated to raise the roof framing system.

FIG. 11 illustrates another view of the plurality of lifting systems being collectively operated to raise the roof framing system.

### DETAILED DESCRIPTION

The detailed descriptions herein describe certain exemplary embodiments relating to containers and the construction of such containers.

General Considerations

As used in this application the singular forms “a,” “an,” and “the” include the plural forms unless the context clearly dictates otherwise. Additionally, the term “includes” means “comprises.” Furthermore, as used herein, the term “and/or” means any one item or combination of items in the phrase. In addition, the term “exemplary” means serving as a non-limiting example, instance, or illustration. As used herein, the terms “e.g.,” and “for example,” introduce a list of one or more non-limiting embodiments, examples, instances, and/or illustrations.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “provide,” “produce,” “determine,” and “select” to describe the disclosed methods. These terms are high-level descriptions of the actual operations that are performed. The actual operations that correspond to these terms will vary depending on the particular implementation and are readily discernible by one of ordinary skill in the art having the benefit of this disclosure.

For the purposes of this disclosure, relative terms such as “vertical”, “horizontal”, “top”, “bottom”, “front”, “back”, “end” and “sides” may be used. It should be understood, however, that the terms are used only for purposes of description, and are not intended to be used as limitations. Accordingly, the orientation of an object or a combination of objects may change without altering the scope of the invention.

As used herein, the term “post frame construction” refers to a building process in which a roof framing system, such as a truss, beam, or other structure, is lifted onto a series of posts or columns to provide the structural framework for a “post frame building.” As used herein, the term “roof framing system” refers to any rigid framework capable of supporting a load (e.g., a roof) over a given span. A roof framing system can include, for example, a single member such as a beam, or a prebuilt framework such as a truss that includes one or more triangular components. Various truss configurations are possible, including pitched or flat trusses.

As used herein, the terms “post” and “column” are used interchangeably to refer to a vertical structure that provides support to a roof framing system. In some cases, posts and columns can be supported by a foundation, such as concrete columns in the ground, concrete slabs, or any other rigid and/or supporting material.

As used herein, the term “cable” refers to any elongated structure on which a force can be exerted to raise or lower a coupling member, such as a cable hook. A cable can include any wire, rope, chain, or other materials of sufficient strength for carrying the loads described herein. As used herein, the term “hook” or “cable hook” refers to a structure with a portion that can receive and/or engage with a component of another structure to, at least temporarily, secure the two members together. In some embodiments, the hook can be a curved or bent device that catches and/or extends at least partially into or around the component of the other structure.

Exemplary Lifting Systems and Methods of Using the Same

Post frame construction is a construction process in which columns are provided and a roof framing system (e.g., a truss) is lifted onto the columns. The columns can be formed of any suitable material, such as wood, laminated wood, steel, etc. Similarly, the truss can be formed from any suitable material, such as wood, laminated wood, steel, etc. During construction, the truss is lifted from the ground into position to be secured to the series of columns that are supported on or in the ground (e.g., with concrete columns or the like).

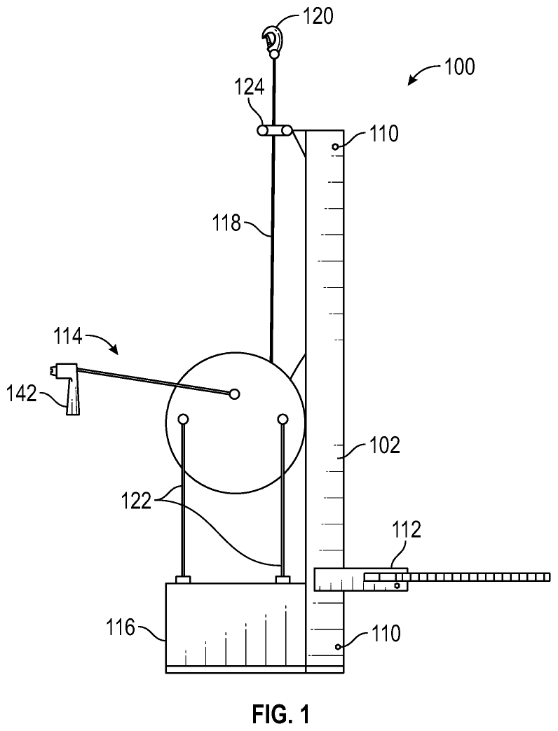

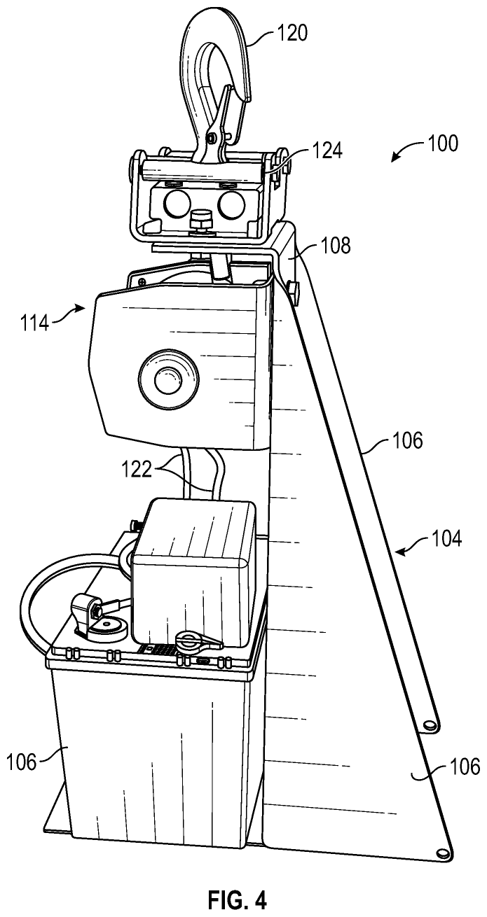

FIGS. 1-4 illustrate embodiments of a lifting system 100 and its related components. Referring to FIG. 1, a roof framing lifting system 100 is illustrated. Lifting system 100 can include a bracket 102 that is secured to a column 104. Bracket 102 can comprise a three-sided structure that partially surrounds the column 104 (FIG. 4). In some embodiments, the bracket 102 can have a pair of facing triangular sides 106 (FIG. 4) that extend from a rectangular member 108. In other embodiments, the bracket 102 can have different shapes or configurations.

One or more securing members can be provided to secure the bracket 102 to the column 104. For example, FIG. 1 illustrates a pair of screw locations 110 for securing the bracket 102 to the column. Additional locking structures, such as chain cam-lock 112 can be provided.

Lifting system 100 can include a winch system 114 that includes a power source 116 (e.g., a battery) that drives a motor that causes a winch cable 118, and a cable hook 120 on the end of winch cable 118, to raise or lower as desired. The winch 114 can be any suitable size or power winch. In some embodiments, the winch 114 can be a 12 volt winch or a 110 volt winch.

If the power source 116 is a battery, battery leads 122 can be coupled from the winch 114 to the power source 116. The lifting system 100 can further comprise one or more cable guides 124 that can help maintain a desired position and/or orientation of the winch cable 118.

Lifting system 100 can further include a truss bracket 126 that can be coupled to and/or secured to a roof framing system (e.g., a truss) 128. In operation, the cable hook 120 can be coupled to the truss bracket 126, which permits the operation of the winch 114 to raise or lower the truss 128. Cable hook 120 can be coupled to the truss bracket 126 in any suitable manner, such as by coupling to lifting point 130 (e.g., a bar or opening that can receive the hook).

To facilitate lifting, the truss bracket 124 can extend under the truss 128 (e.g., a three-sided bracket with a central side under and supporting the truss 128). In addition, one or more guide members 132 can be provided to facilitate smooth operation of the lifting of the truss 128. For example, guide members 132 can include one or more rollers 133 that help to maintain the position of the truss 128 adjacent column 104, and allow easy movement of the truss relative to the column, as the truss 128 is raised or lowered along a length of the column 104. The winch 114 can be controlled by any suitable means, such as a wired remote control device 142 as shown in FIG. 1.

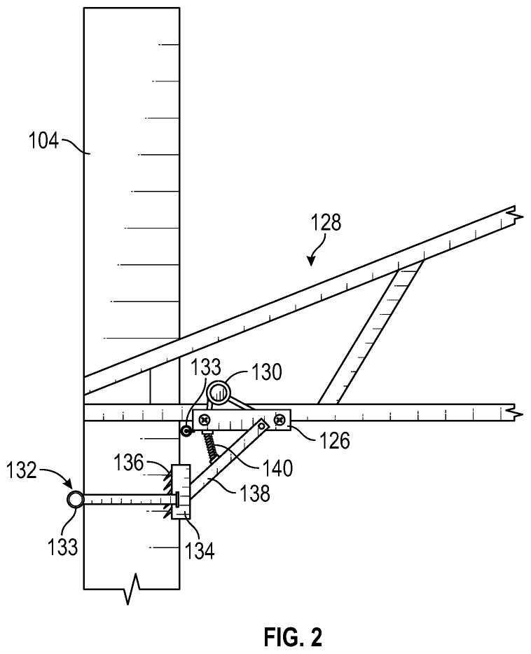

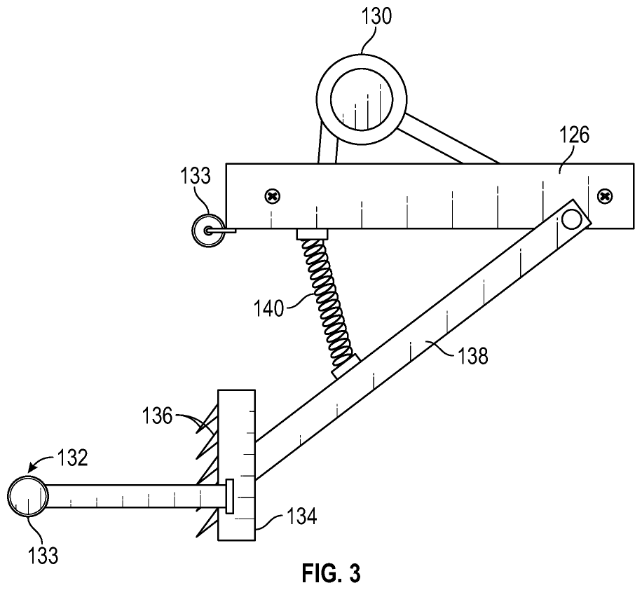

In some embodiments, a braking system 134 can be provided to prevent the rapid descent of the truss 128 in the event of a failure of the lifting system 100. In one embodiment, the braking system 134 can include a structure that only permits movement of the truss in the vertical direction. For example, as shown in FIGS. 2 and 3, the braking system can include angled spike members 136 that restrict the downward movement of the truss relative to the column. The braking system 134 can extend from a fail brake arm 138 and, in some embodiments, a spring member 140 can be provided to bias the fail brake arm 138 toward the column.

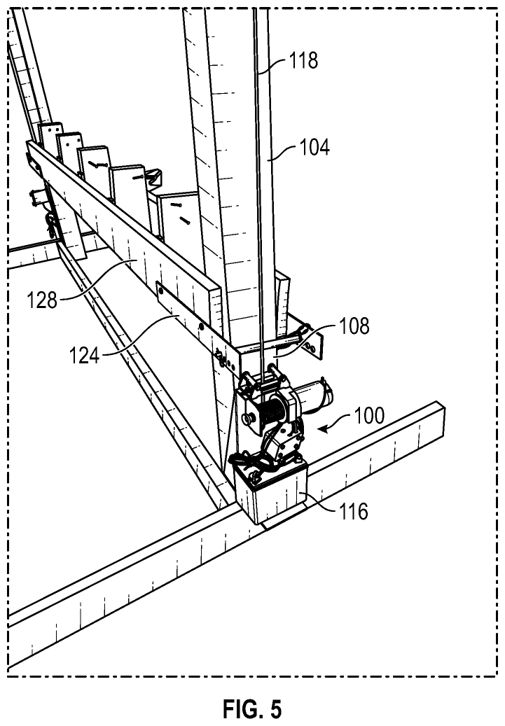

FIGS. 5-8 illustrate a method of using lifting system 100 to raise a truss 128. As shown in FIG. 5, the lifting system 100 is coupled to a column 104 and truss bracket 124 is coupled to a truss 128. Winch 114 is operated to raise the truss 128 by pulling the winch cable 118 and, as such, raising the cable hook 120 coupled to the truss 128.

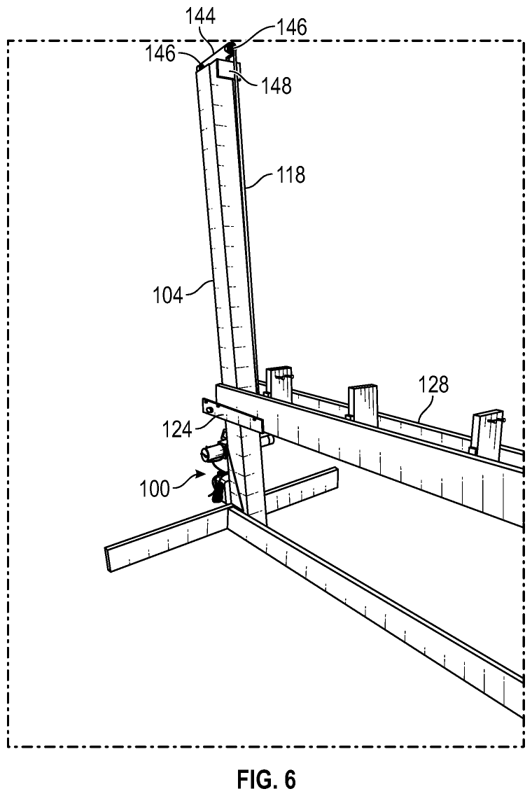

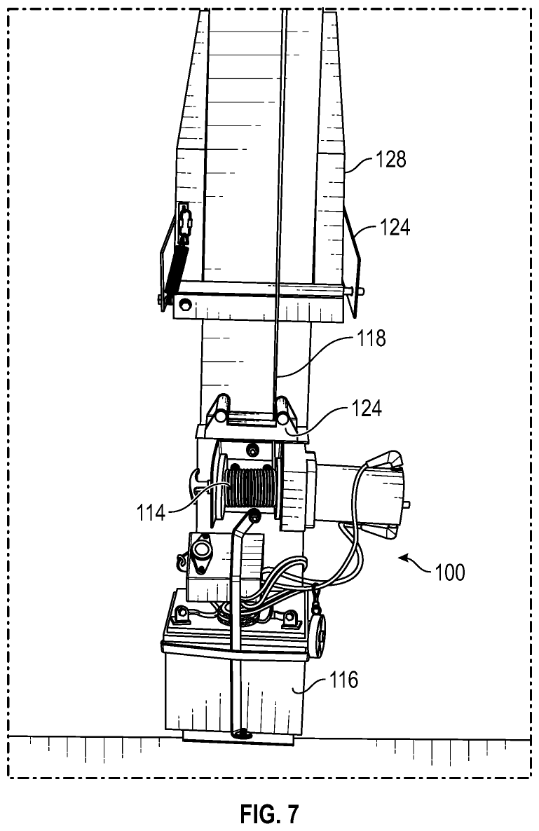

FIGS. 6 and 7 show additional views the lifting system 100. As shown in FIG. 6, the lifting system 100 includes a pulley system 144 that is positioned on and/or coupled to a top portion of the column 104. The pulley system 144 comprises at least two spaced-apart pulley wheels 146 that change the direction of the winch cable 118 across the pulley system 144. In some embodiments, the pulley system can comprise a pulley support frame 148 (e.g., a bracket) that extends across and supports the pulley wheels 146.

The pulley frame can be configured to at least partially surround a top portion of the column, e.g., by having at least three sides (e.g., one facing the top surface of the column and at least two facing the top sides of the column). The pulley system can be secured to the column in any known manner as needed. For example, one or more screws can be used to secure the pulley system. Alternatively, the pulley system can form a complete cap on the top of the column, and the weight of the pulley system, and the loads carried by the pulley system, can maintain the pulley system in the desired position. In other embodiments, the pulley frame can clamp to the top of the column and/or otherwise be biased into contact with top of the column, such as by a spring secured to opposing sides that are movable relative to one another (e.g., a spring-loaded cap member).

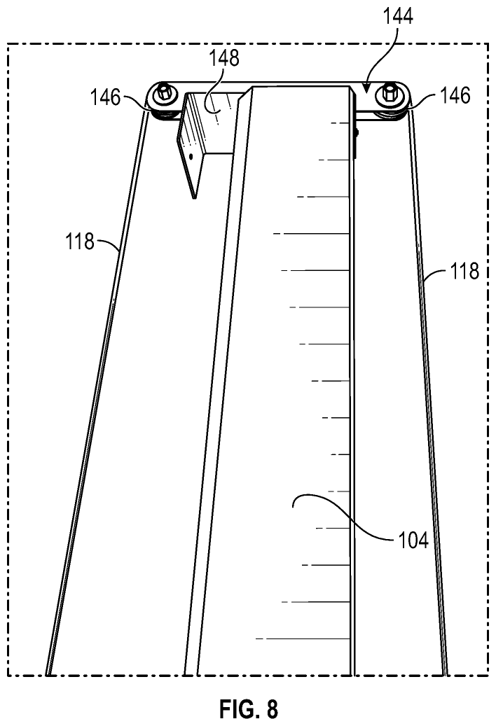

FIG. 8 illustrates another view of the pulley system 144, showing one example of the manner in which the pulley support frame 148 and pulley wheels 146 can engage with a top surface of the column 104.

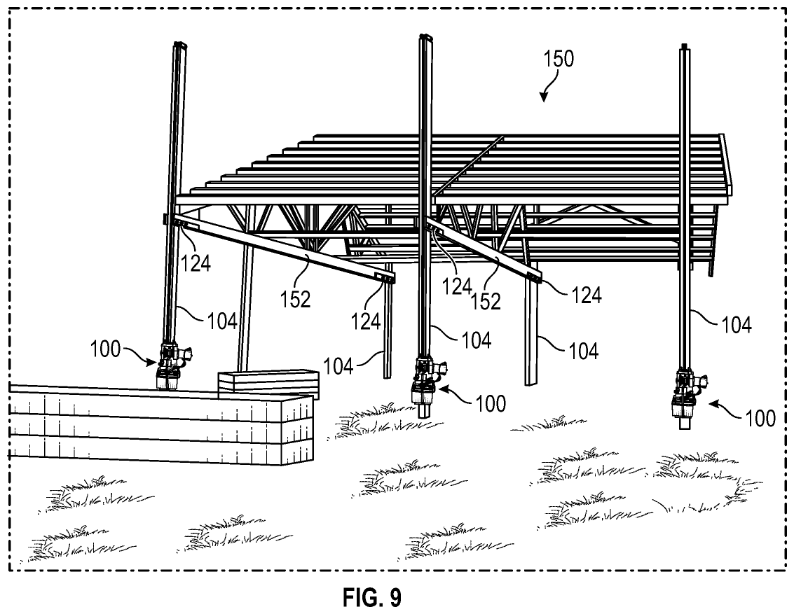

FIGS. 9-11 illustrate a roof framing system 150 being raised by a plurality of lifting systems 100, each configured to raise a portion of the roof framing system 150 through a different column 104. Although FIG. 9 only illustrates lifting systems 100 positioned on the columns 104 in the foreground, it should be understood that complementary lifting systems 100 are position on the columns 104 opposing the columns shown with a lifting system attached. For example, as shown in FIG. 9, each side of the bottom chords 152 of the roof framing system 150 is supported by and/or secured to truss brackets 124, which are in turn coupled to the cable hook of the winch systems.

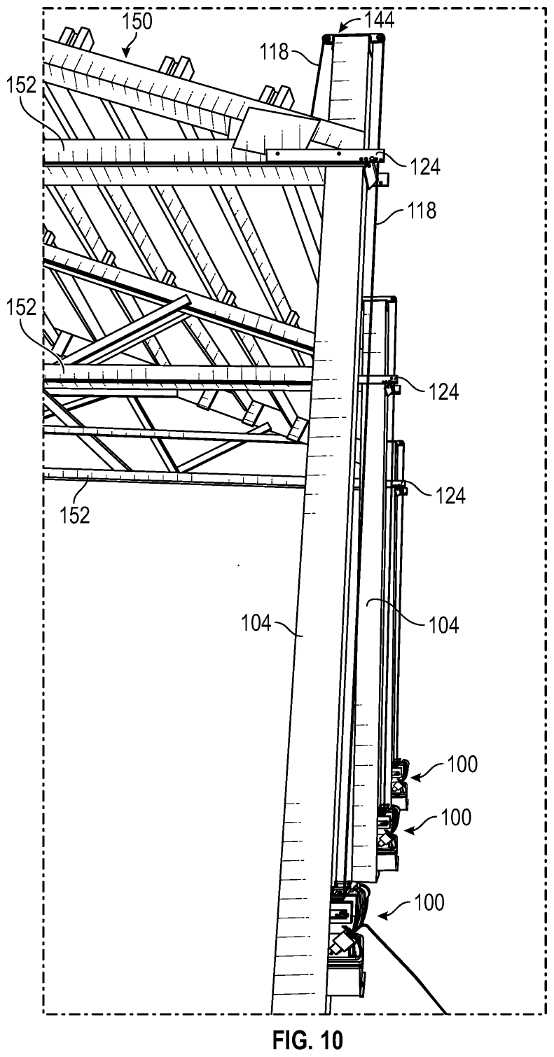

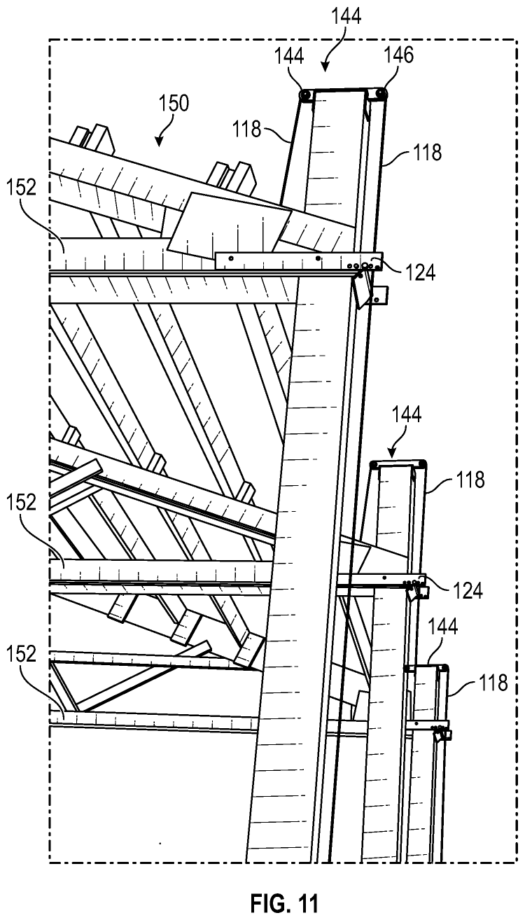

As shown in FIGS. 10 and 11, each side of the bottom chords 152 of the roof framing system 150 are supported by and/or secured to truss brackets 124 so that the entire roof framing system 150 can be lifted together at the same time.

In operation, the lifting system can be operated more easily and safely than conventional post frame construction systems and/or pole barn systems. In one mode of operation, the winch bracket can be attached to the lower portion (e.g., a bottom) of the column. The winch bracket can be secured to the column in any suitable manner. Then, the double roller frame (bracket) can be positioned on the top of the column and secured thereto (e.g., by screws or bolts). The winch cable can be pulled up and over the column, placing the cable in the roller tracks of the double roller pulley system and positioning the cable hook near the ground and/or the roof framing system (e.g., truss) that is to be raised. The truss bracket can be secured to the truss and the cable hook secured to an attachment point on the bracket and/or truss. If multiple lifting systems are being used, the above steps can be repeated for each lifting system/column arrangement. Once all steps are complete and each lifting system is coupled to a portion of the truss, the winch systems can be operated to raise the roof framing system. Each lifting system can have a controller and by operating the controllers in sequence, the roof framing system can be raised to the desired installation height. Once the desired installation height is reach, the truss can be permanently secured to each column, such as by nailing, bolting, etc. The truss can be maintained at the installation height by the winch system and/or by the braking system which restricts downward movement of the truss. Once all portions of the truss are secured, the hooks can be released and the lifting system brackets (on the base and top of the column, and on the truss) can be removed.

In one embodiment, each lifting system can be configured to receive instructions wirelessly, so that when multiple lifting systems are used in a post frame construction project, a central control device can simultaneously provide the same operational instructions to each winch system.

Although the lifting system is described in the context of raising a roof framing system using one or more columns, it should be understood that the lifting systems described herein can be used to lift any objects adjacent to a post or column structure.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. A lifting system comprising:
a winch system coupled to a frame, the frame being configured to be secured to a lower portion of a column of a building structure;
a first bracket configured to be secured to a portion of a roof framing system; and
a pulley system comprising at least two pulley wheels mounted on a second bracket, the second bracket being configured to be secured to a top of the column.

2. The lifting system of claim 1, wherein the winch system comprises a winch cable, a cable hook at a first end of the winch cable, and a motor configured to generate rotational power to raise the cable hook.

3. The lifting system of claim 2, wherein the winch cable extends from the winch system and engages with the at least two pulley wheels of the pulley system.

4. The lifting system of claim 1, wherein the frame comprises a first side, a second side, and a third side, and
wherein the first and third sides are facing one another and the second side is intermediate the first and second sides to provide a three-sided bracket.

5. The lifting system of claim 4, wherein the first and second sides are triangular in shape.

6. The lifting system of claim 4, wherein the first and second sides are rectangular in shape.

7. The lifting system of claim 1, wherein the first bracket comprises at least three sides.

8. The lifting system of claim 1, wherein the winch system comprises a power source that is a battery.

9. The lifting system of claim 1, wherein the winch system comprises a cable guide secured to the frame.

10. The lifting system of claim 1, wherein the first bracket comprises a braking system.

11. The lifting system of claim 10, wherein the braking system comprises one-way angled spike members.

12. The lifting system of claim 10, wherein first bracket comprises one or more rollers to facilitate movement of the roof framing system relative to the column.

13. A method of raising a roof framing system along a column, the method comprising:
coupling a frame to a lower portion of a column of a building structure, the frame having a winch system secured thereto;
coupling a first bracket to a portion of a roof framing system;
coupling a second bracket of a pulley system to a top of the column, the pulley system comprising at least two pulley wheels mounted on the second bracket;
engaging a cable of the winch system with the at least two pulley wheels;
coupling a securing member of the winch system to a structure on the first bracket; and
driving a motor of the winch system to raise the roof framing system along a desired length of the column.

14. The method of claim 13, further comprising positioning the cable through a cable guide secured to the frame.

15. The method of claim 13, further comprising engaging a braking system to restrict downward movement of the roof framing system.

16. The method of claim 15, wherein the braking system comprises one-way angled spike members.

17. The method of claim 13, further comprising engaging one or more rollers on the first bracket with the column to facilitate movement of the roof framing system relative to the column.

18. The method of claim 13, further comprising securing the roof framing system to the column when the roof framing system has been raised to a desired installation height.

19. The method of claim 13, wherein the roof framing system is a truss.

20. A method of raising a roof framing system along a column, the method comprising:
coupling a plurality of lifting systems to respective lower portions of a plurality of columns, each lifting system comprising a frame having a winch system secured thereto;
coupling a plurality of first brackets to respective portions of a roof framing system;
coupling a plurality of pulley systems to the tops of the plurality of columns, each pulley system comprising at least two pulley wheels;
engaging a cable of each of the winch systems with the at least two pulley wheels;
coupling a securing member of each of the winch systems to a respective structure on the plurality of first brackets; and
driving a motor of each of the plurality of lifting systems to raise the roof framing system to a desired installation height.

21. The method of claim 19, wherein the motors of each of the plurality of lifting systems are driving simultaneously.
